(19) United States
(12) Patent Application Publication
(10) Pub. No.: US 2016/0308192 A1
(43) Pub. Date: Oct. 20, 2016

(54) POSITIVE ELECTRODE FOR A LITHIUM ION BATTERY AND LITHIUM ION BATTERY USING THE SAME

(71) Applicant: Hyundai Motor Company, Seoul (KR)

(72) Inventors: Sang Heon Lee, Yongin (KR); Kyo Min Shin, Hwaseong (KR); Sung Hoon Lim, Gunpo (KR); Sang Mok Park, Seongnam (KR); Shin Kook Kong, Seoul (KR)

(21) Appl. No.: 14/929,962

(22) Filed: Nov. 2, 2015

(30) Foreign Application Priority Data
Apr. 17, 2015 (KR) 10-2015-0054548

(51) Int. Cl. H01M 4/13; H01M 4/62; H01M 4/04; H01M 10/0525

(52) U.S. Cl. CPC H01M 4/13; H01M 10/0525; H01M 4/622; H01M 4/623; H01M 4/625; H01M 4/0404; H01M 2220/20

(57) ABSTRACT

Disclosed are a positive electrode for a lithium ion battery and a lithium ion battery comprising the same. The positive electrode for a lithium ion battery includes a composite conductive layer comprising a binder and a conductive and is formed on a positive electrode active material layer, such that output and safety is improved at the same time. Further, battery life time is improved by inhibiting reaction on the interface between the electrode active material and a separator.

### CROSS-REFERENCE TO RELATED APPLICATION

This application claims under 35 U.S.C. §119(a) the benefit of Korean Patent Application No. 10-2015-0054548 filed on Apr. 17, 2015, the entire contents of which are incorporated herein by reference.

### TECHNICAL FIELD

The present invention relates to a positive electrode for a lithium ion battery and a lithium ion battery using the same. In particular, the positive electrode for a lithium ion battery may include a composite conductive layer comprising a binder and a conductive material such that output and safety may be improved at the same time. Further, improved battery life time may be achieved by inhibiting reaction on the interface between the electrode active material and a separator.

### BACKGROUND

It has been constantly studied to achieve high capacity of a battery for a vehicle, and needs for increasing capacity will be continued in the future. However, in the battery for a vehicle requiring high capacity and high output at the same time, safety characteristic may be rapidly deteriorated in return when a design for high energy of the battery is applied. In particular, output improvement and perforation characteristic may be in relation of trade off.

On the other hand, unit structure of a lithium ion secondary battery generally consists of a laminated structure of a positive electrode base/a positive electrode mixture/a separator/an anode mixture/an anode base and the like. In recent, in order to improve safety of a high capacity lithium ion battery by preventing diffusion of an internal short, for example, an insulating layer has been formed on the positive electrode mixture, the anode mixture, one side of the separator or both sides of the separator and the like, or coating with ceramic-based material, which is a non-conductive material having no electrical conductivity, has been much tried, and some of them have been commercially available.

However, securing safety by forming this insulating layer may be a disadvantageous factor for increasing energy content per weight and the like, and the insulating layer may not work effectively at a certain energy level or higher. Further, when the insulating layer is applied to a battery necessarily requiring high output characteristic, for example, a battery for a vehicle, safety item characteristic such as perforation may be rapidly deteriorated, and performance such as energy density (energy content per weight) or battery capacity may be substantially reduced again when the characteristic is complemented.

In the related arts, Japanese Patent Publication No. 5237642 discloses an electrode for a lithium secondary battery, and an active material structure layer formed on a positive electrode current collector comprises the first layer including a material absorbing and releasing a lithium ion and the second layer including a conductive material that is not chemically reacting with lithium. However, output and safety characteristics may not be obtained sufficiently at the same time.

Further, Korea Patent Laid-Open Publication No. 2013-050473 discloses a positive electrode for a secondary battery, which comprises a positive electrode active material providing high output, the first active material layer formed on a positive electrode current collector and the second active material layer comprising positive electrode active material providing relatively high capacity and formed on the first active material layer. However, performance requirement, for example, safety item such as perforation and the like and capacity performance and the like may not be sufficient.

Further, Korea Patent Publication No. 441513 discloses an active material for a battery comprising a conductive material-coated layer, which contains a conductive material and a conductive polymer dispersant. However, safety characteristic and performance such as energy density (energy content per weight) or battery capacity and the like at the same time may not be sufficiently improved.

Thus, there are needs for researches for embodying a novel lithium ion battery, which can output and safety characteristics of a battery at the same time.

The above information disclosed in this Background section is only for enhancement of understanding of the background of the invention and therefore it may contain information that does not form the prior art that is already known in this country to a person of ordinary skill in the art.

### SUMMARY OF THE INVENTION

In preferred aspects, the present invention has been made in an effort to solve the above-described problems in the related arts.

The present invention provides a composite conductive layer that may comprise a binder and a conductive material and may be applied on a positive electrode active material layer. As such, safety of the lithium ion battery may be enhanced by improving output characteristic and instant discharging ability at a very low temperature and by excellent heat rejection at the same time, thereby improving battery life time.

Accordingly, the present invention provides a positive electrode for a lithium ion battery having improved output and safety characteristic.

Further, the present invention provides a lithium ion battery may comprise the positive electrode having improved battery life time characteristic.

In one aspect, the present invention provides a positive electrode for a lithium ion battery comprising: a positive electrode current collector; a positive electrode active material layer formed on the positive electrode current collector; and a composite conductive layer formed on the positive electrode active material layer. In particular, the composite conductive layer may comprise a binder and a conductive material, preferably, at weight ratio of about 1:about 0.5 to 10.

The binder may be polyurethane, polyvinylidene fluoride (PVdF) or a mixture thereof, and the conductive material may be at least one selected from the group consisting of artificial graphite, natural graphite, Ketjen black, carbon nanotube, carbon nanofiber, acetylene black, carbon black and vapor grown carbon fiber (VGCF).

The composite conductive layer may have a thickness of about 1 to 30 μm. In another aspect, the present invention provides a lithium ion battery comprising the positive electrode as described above.

Still further provided are vehicles that comprise the lithium ion battery as described above.

Further, the present invention provides a method of manufacturing a positive electrode for a lithium ion battery. The method may comprise: providing a positive electrode current collector; forming a positive electrode active material layer on the positive electrode current collector; and forming a composite conductive layer on the positive electrode active material layer. In particular, the composite conductive layer may be prepared by mixing a binder and a conductive material at weight ratio of about 1:about 0.5 to 10.

The binder may be polyurethane, polyvinylidene fluoride (PVdF) or a mixture thereof and the conductive material may be at least one selected from the group consisting of artificial graphite, natural graphite, Ketjen black, carbon nanotube, carbon nanofiber, acetylene black, carbon black and vapor grown carbon fiber (VGCF).

The composite conductive layer may have a thickness of about 1 to 30 μm.

In addition, the present invention provides a method of manufacturing a lithium ion battery which may comprise: sequentially stacking a positive electrode current collector, a positive electrode active material layer, a composite conductive layer, a separator, an anode active material layer and an anode current collector and laminating thereof. Particularly, the composite conductive layer comprises a binder and a conductive material at weight ratio of about 1:about 0.5 to 10. Other aspects and preferred embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 illustrates a cross sectional view of an exemplary positive electrode for a lithium ion battery according to an exemplary embodiment of the present invention;

FIG. 2 illustrates a structural view of an exemplary lithium ion battery according to an exemplary embodiment of the present invention; and

FIG. 3 is a graph showing discharging capacity of lithium ion batteries which are manufactured in Examples 1 and 2, and Comparative Example, at a temperature of about −15° C.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The present invention provides a positive electrode for a lithium ion battery which may comprise: a positive electrode current collector; a positive electrode active material layer formed on the positive electrode current collector; and a composite conductive layer comprising a binder and a conductive material and formed on the positive electrode active material layer. Particularly, the composite conductive layer may comprise the binder and the conductive material at weight ratio of about 1:about 0.5 to 10. The composite conductive layer may be a simple mixture, or a composite of the binder and the conductive material.

Preferably, the positive electrode for a lithium ion battery may include the separately formed composite conductive layer comprising the binder and the conductive material on the positive electrode active material layer such that may have greater content of the conductive material than the conventional positive electrode comprising the positive electrode active material, the conductive material and the binder at the same time, thereby providing about 10 times or greater electrical conductivity than the conventional positive electrode.

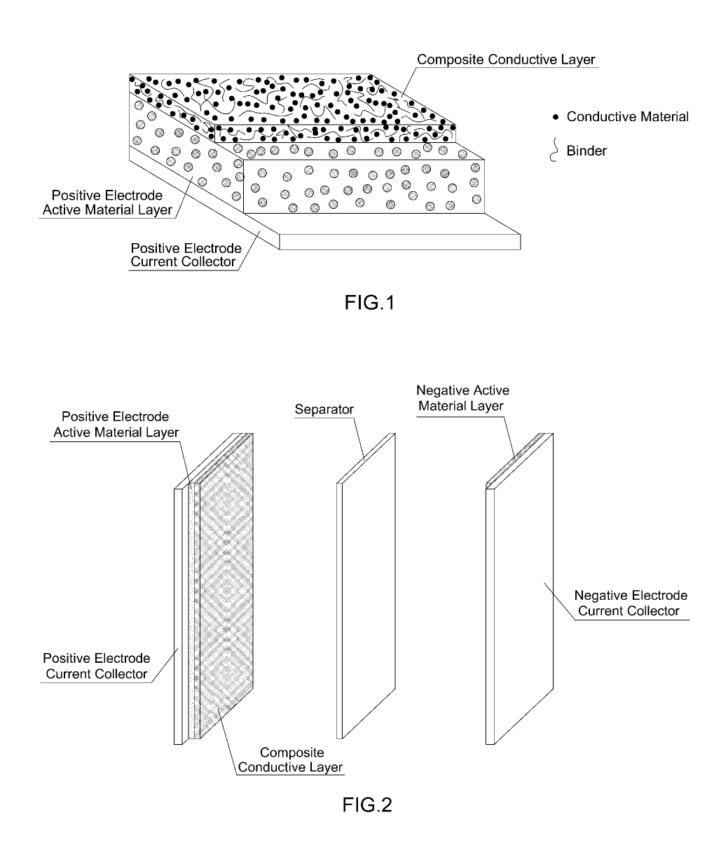

FIG. 1 shows a cross section of an exemplary positive electrode for a lithium ion battery according to an exemplary embodiment of the present invention. As can be seen in FIG. 1, it is found that the composite conductive layer, which includes the binder and the conductive material on the positive electrode active material layer, is formed with reduced thickness.

In particular, the positive electrode active material may be at least one selected from the group consisting of LiCoO₂, LiNi_{0.5}Mn_{1.5}O₄, LiMn₂O₄ and LiFePO₄.

Preferably, when safety issue arises, the composite conductive layer may have improved heat rejection characteristic by controlling thickness and compactness and the like, and may enhance safety such as perforation characteristic and the like. When the content ratio of the binder and the conductive material is less than about 1:about 0.5, electrical conductivity of such composite conductive layer may not be sufficient and resistance thereof may be increased, thereby reducing battery life time performance. When it greater than about 1:about 10, bonding strength of the composite conductive layer to the electrode may be reduced, such that the electrode active materials may be deintercalated from the electrode mixture, or electrical isolation may occur during the battery life time. Thus, it may cause bad influence for maintaining life time performance.

Preferably, the binder may be polyurethane, polyvinylidene fluoride (PVdF) or a mixture thereof, but the examples thereof may not be limited thereto. Further, the binder also may be used to form the composite conductive layer having conductivity, and adhesiveness may be given by making in the form of a jelly-roll and then by conducting hot rolling and the like.

Further, the conductive material may be at least one selected from the group consisting of artificial graphite, natural graphite, Ketjen black, carbon nanotube, carbon nanofiber, acetylene black, carbon black and vapor grown carbon fiber (VGCF).

Preferably, the composite conductive layer may have a thickness of about 1 to 30 μm. When the thickness of the composite conductive layer is less than about 1 μm, suitable layer thereof may not be formed, and battery performance may be deteriorated due to its low electrical conductivity. When it is greater than about 30 μm, battery capacity may be reduced, and also ion conductivity may be deteriorated, thereby reducing life characteristic and the like. As such, the thickness of the composite conductive layer may be in a range from about 10 to about 25 μm, of particularly from about 12 to about 18 μm. Further, because perforation characteristic and life time characteristic may be related as being trade-off to each other, when the thickness of the composite conductive layer becomes thinner, perforation characteristic may become better, and when thickness thereof becomes thicker, life time characteristic may become better. Thus, thickness may be easily controlled within the said range depending on the condition required based on design of the battery.

The present invention also provides a lithium ion battery, which comprises the positive electrode as described above.

FIG. 2 illustrates a structural view of an exemplary lithium ion battery according to an exemplary embodiment of the present invention. As shown in FIG. 2, the lithium ion battery may have a structure of a positive (cathode) electrode current collector/a positive electrode active material layer/a composite conductive layer/a separator/an anode (negative) active material layer/an anode current collector, which may be stacked and sequentially laminated.

The positive electrode for a lithium ion battery according to the present invention may improve output characteristic and instant discharging ability at a very low temperature by applying the composite conductive layer comprising the binder and the conductive material on the positive electrode active material layer. Further, when safety issue arises, safety such as perforation may be enhanced due to excellent heat rejection characteristic, and even at an unexpected extreme situation, the emergence of the issue of the battery itself may be prevented by causing a micro-short early with excellent heat rejection. Further, by applying the composite conductive layer between the electrode and the separator, oxidation may be prevented by inhibiting reaction on the interface between the electrode active material and the separator, and when additionally providing adhesion function by increasing the binder amount, an error such as deposition of salts caused by loosed gap between the electrode and the separator is prevented, thereby improving battery life time.

### EXAMPLES

The following examples illustrate the invention and are not intended to limit the same.

### Example 1

A positive electrode was prepared by mixing an active material LiNi_{1/3}Co_{1/3}Mn_{1/3} 94 wt %:PVdF 3 wt %:acetylene black 3 wt %, coating thereof on an Al current collector in a certain amount, and then rolled to a desired thickness at a temperature of 110° C. Then, polyurethane binder 8 wt % and water 92 wt % were stirred using a mixer for 2 hours to manufacture a binder solution for manufacturing a composite conductive material slurry for additional coating. Then, a conductive material, i.e. acetylene black, was mixed to the binder solution at a weight ratio of 1:2, and fully stirred using a bead mill mixer having strong torque to manufacture the composite conductive material slurry. Then, the composite conductive material slurry was coated on the previously prepared positive electrode active material layer of the positive electrode, which was manufactured by rolling the positive electrode current collector and the positive electrode active material layer, using a slot die coater followed by drying thereof to manufacture a positive electrode, on which the 12 μm-thick composite conductive layer is formed. Then, the electrode was vacuum dried at a temperature of 110° C., and then notched to a desired size to prepare a positive electrode composite layer electrode.

A negative electrode was prepared by mixing natural graphite 98 wt %:CMC 1 wt %:SBR 1 wt %, coating the mixture on a Cu current collector in a predetermined amount, and then rolling at a room temperature. Then, it was vacuum dried at a temperature of 140° C. and then notched to a desired size to prepare a negative electrode.

Then, the prepared positive electrode composite layer (composite conductive layer of 12 μm thickness) electrode, the negative electrode and the separator were prepared and stacked by sequentially laminating in an order of a negative electrode/a separator/a positive electrode/a separator/a negative electrode/a separator/a positive electrode/a separator/a negative electrode within a range having about 30 Ah-grade capacity, followed by putting thereof in a pouch. Then, a lithium salt-containing electrolyte was again injected thereto, and then a pouch-type lithium ion battery of about 30 Ah-grade was prepared through an aging process.

### Example 2

The procedure of Example 1 was repeated except for manufacturing a positive electrode on which a 18 μm-thick composite conductive layer was formed, by coating the composite conductive material slurry of Example 1 using a slot die coater followed by drying thereof to manufacture a lithium ion battery.

### Comparative Example

The procedure of Example 1 was repeated except for not forming the composite conductive layer (0 μm) on the positive electrode to manufacture a lithium ion battery.

### Test Example

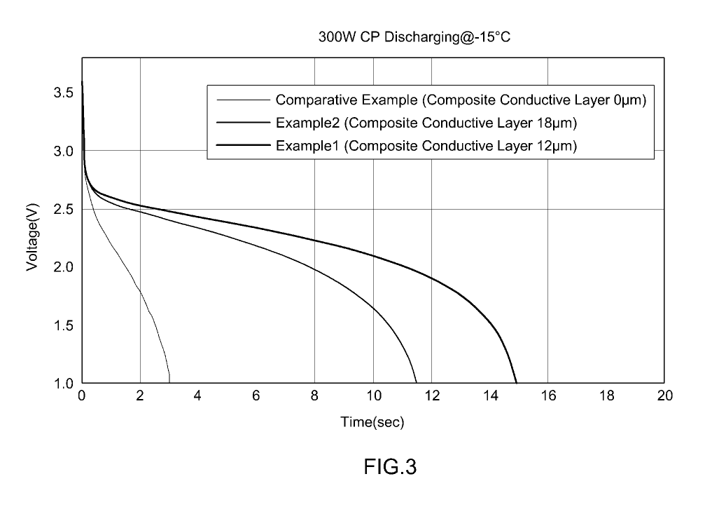

For the lithium ion batteries manufactured in Examples 1 and 2, and Comparative Example, discharging capacity when discharged at a very low temperature (−15° C.) was measured, and the results are shown in the following FIG. 3.

FIG. 3 is a graph showing discharging capacity of the lithium ion batteries, manufactured in Examples 1 and 2, and Comparative Example, at a temperature of −15° C.

As shown in FIG. 3, the battery of Comparative Example was discharged for 3 sec at a very low temperature, but the batteries of Examples 1 and 2 were discharged for about 15 sec and 11 sec, respectively. Accordingly, it was confirmed that the discharging time of the batteries of Examples were largely increased. Through this, it was confirmed that electrical conductivity on the surface of the positive electrode may be improved by coating the composite conductive layer to the existing positive electrode, thereby improving output of the battery itself at a low temperature. Thus, in the above tests, Example 1 using the composite conductive layer of 12 μm showed the best discharging ability (life time characteristic). Through this, it could be found that in designing a battery, an area of the battery (discharging capacity, life time characteristic), which can be complemented by controlling thereof according to the required characteristics such as discharging capacity, safety, output and the like, may be broaden.

Consequently, it was confirmed that the positive electrodes for a lithium ion battery manufactured in Examples may improve output characteristic and instant discharging ability at a very low temperature. Further, when a safety issue is emerging, heat rejection property may be enhanced by controlling thickness of the composite conductive layer, thereby improving safety such as perforation, and the emergence of an issue of the battery itself may be prevented by causing a micro-short early with excellent heat rejection property even at an unexpected extreme situation. Further, oxidation may be prevented by inhibiting reaction on the interface between the electrode active material and the separator, and by additionally providing adhesion function with increased amount of the binder, defects such as deposition of salts caused by loosed gap between the electrode and the separator may be prevented. As consequence, battery life time may be improved.

The positive electrode for a lithium ion battery of the present invention may provide improved electrical conductivity and may improve output characteristic and instant discharging ability at a very low temperature by applying the composite conductive layer on the positive electrode active material layer. In particular, the composite conductive layer may comprise the binder and the conductive material at the predetermined weight ratio.

Further, when a safety issue is emerging, safety such as perforation may be improved due to its excellent heat rejection property, and the emergence of an issue of the battery itself may be prevented by causing a micro-short early with improved heat rejection property even at an unexpected extreme situation.

Further, by applying the composite conductive layer between the electrode and the separator, oxidation may be prevented by inhibiting reaction on the interface between the electrode active material and the separator, and since increased amount of the binder is additionally provided to improve adhesion function, defects such as deposition of salts caused by loosed gap between the electrode and the separator may be prevented, thereby improving battery life.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A positive electrode for a lithium ion battery, comprising:
a positive electrode current collector;
a positive electrode active material layer formed on the positive electrode current collector; and
a composite conductive layer formed on the positive electrode active material layer,
wherein the composite conductive layer comprises a binder and a conductive material at weight ratio of about 1:about 0.5 to 10.

2. The positive electrode of claim 1, wherein the binder is polyurethane, polyvinylidene fluoride (PVdF) or a mixture thereof.

3. The positive electrode of claim 1, wherein the conductive material is at least one selected from the group consisting of artificial graphite, natural graphite, Ketjen black, carbon nanotube, carbon nanofiber, acetylene black, carbon black and vapor grown carbon fiber (VGCF).

4. The positive electrode of claim 1, wherein the composite conductive layer has a thickness of about 1 to 30 μm.

5. A lithium ion battery, comprising a positive electrode for a lithium ion battery of claim 1.

6. A vehicle that comprises a lithium ion battery of claim 5.

7. A method of manufacturing a positive electrode for a lithium ion battery, comprising:
providing a positive electrode current collector;
forming a positive electrode active material layer on the positive electrode current collector; and
forming a composite conductive layer on the positive electrode active material layer,
wherein the composite conductive layer is prepared by mixing a binder and a conductive material at weight ratio of about 1:about 0.5 to 10.

8. The method of claim 7, wherein the binder is polyurethane, polyvinylidene fluoride (PVdF) or a mixture thereof.

9. The method of claim 7, wherein the conductive material is at least one selected from the group consisting of artificial graphite, natural graphite, Ketjen black, carbon nanotube, carbon nanofiber, acetylene black, carbon black and vapor grown carbon fiber (VGCF).

10. The method of claim 7, wherein the composite conductive layer has a thickness of about 1 to 30 μm.

11. A method of manufacturing a lithium ion battery, comprising:
sequentially stacking a positive electrode current collector, a positive electrode active material layer, a composite conductive layer, a separator, an anode active material layer and an anode current collector and laminating thereof,
wherein the composite conductive layer comprises a binder and a conductive material at weight ratio of about 1:about 0.5 to 10.
